(19) United States
(12) Patent Application Publication
(10) Pub. No.: US 2020/0324376 A1
(43) Pub. Date: Oct. 15, 2020

(54) OPTICAL DEVICE AND METHOD FOR MANUFACTURING OPTICAL DEVICE

(71) Applicant: SUMITOMO ELECTRIC INDUSTRIES, LTD., Osaka (JP)

(72) Inventors: Shigehiro NAGANO, Osaka-shi (JP); Tetsu MORISHIMA, Osaka-shi (JP)

(73) Assignee: SUMITOMO ELECTRIC INDUSTRIES, LTD., Osaka (JP)

(21) Appl. No.: 16/912,808

(22) Filed: Jun. 26, 2020

Related U.S. Application Data
(63) Continuation of application No. PCT/JP2018/046822, filed on Dec. 19, 2018.

(30) Foreign Application Priority Data
Jan. 11, 2018 (JP) 2018-002656

(51) Int. Cl. B23K 26/53; B29D 11/00

(52) U.S. Cl. CPC B23K 26/53; B23K 2101/34; B29D 11/00009

(57) ABSTRACT

A method for manufacturing an optical device according to an embodiment comprises: loading hydrogen into a glass member containing Ge; irradiating a laser beam from a femtosecond laser into the glass member having the hydrogen loaded therein, the laser beam having an amount of energy causing a light-induced change in refractive index of the glass member and having a repetition frequency of 10 kHz or higher; and moving a light convergence point position of the laser beam relative to the glass member. A repetition of the irradiating and the moving forms a continuous refractive index changed region in the glass member.

### CROSS-REFERENCE TO RELATED APPLICATIONS

This application is a continuation application of PCT/JP2018/046822 claiming the benefit of priority of the Japanese Patent Application No. 2018-002656 filed on Jan. 11, 2018, the entire contents of which are incorporated herein by reference.

### TECHNICAL FIELD

The present disclosure relates to an optical device and a method for manufacturing an optical device.

This application claims the priority of Japanese Patent Application No. 2018-002656 filed on Jan. 11, 2018, which is incorporated herein by reference in its entirety.

### BACKGROUND ART

In a technical field such as optical network communication, with the expansion of cloud services, the scale of data centers and the capacity of communication data are rapidly increasing. As an example, formation of an optical IC on the basis of silicon photonics and application of a multi-core optical fiber (hereinafter, referred to as “MCF”) as high-density optical wiring are under consideration, for example. Attention is being given to the MCF as the next generation large capacity optical fiber because the MCF can serve as a means of avoiding, by space division multiplexing, an allowable limit due to a fiber fuse caused by high-power light beam incident on an optical fiber. However, in order to adopt an optical component such as the MCF, a technique of connecting between adjacent MCFs or a technique of branch connection of each core of the MCF to a plurality of single-core fibers is essential. As components that enable connection between such optical components, a low-profile coupler, a grating coupler, and the like are available, for example. In particular, attention is being given to manufacture of a three-dimensional optical waveguide device that forms an optical waveguide in glass by laser drawing from the viewpoint of productivity and design flexibility.

For such a three-dimensional optical waveguide device based on laser drawing that has been announced so far, glass materials, dopants, amounts of dopants, and irradiation conditions of a femtosecond laser (up to 800 nm) based on Ti:S are under study. For example, according to Non Patent Document 1, irradiating a phosphate-based glass containing TiO₂ with a laser beam successfully produces a change in refractive index (a difference in refractive index between a base material and a laser irradiation region) Δn in the glass of about 0.015 (manufacture of the three-dimensional optical waveguide device).

### CITATION LIST

### Patent Literature

Patent Document 1: Japanese Patent Application Laid-Open No. H9-311237
Patent Document 2: Japanese Patent Application Laid-Open No. H10-288799

### Non-Patent Literature

Non-Patent Document 1: Masakiyo Tonoike, “The result of the finished national project on “High-efficiency Processing Technology for 3-D Optical Devices in Glass””, NEW GLASS Vol. 26, No. 3, 2011, pp. 33-44
Non-Patent Document 2: D. L. Williams, et al., “ENHANCED UV PHOTOSENSITIVITY IN BORON CODOPED GERMANOSILICATE FIBERS”, ELECTRONICS LETTERS, 7 Jan. 1993, Vol. 29, No. 1, pp. 45-47
Non-Patent Document 3: B. I. Greene, et al., “Photoselective Reaction of H₂ with Germanosilicate Glass”, LEOS '94 (1994), Vol. 2, PD-1.2, pp. 125-126
Non-Patent Document 4: Junji Nishii, et al., “Ultraviolet-radiation-induced chemical reactions through one- and two-photon absorption process in GeO₂—SiO₂ glasses”, OPTICS LETTERS, Vol. 20, No. 10, May 15, 1995, pp. 1184-1186

### SUMMARY OF INVENTION

A method for manufacturing an optical device according to the present disclosure includes at least a hydrogen loading step, a laser irradiation step, and a light convergence point movement step. A repetition of the laser irradiation step and the light convergence point movement step forms a continuous refractive index changed region in a glass member to be irradiated with a laser. Specifically, in the hydrogen loading step, hydrogen is loaded into the glass member containing Ge. In the laser irradiation step, a laser beam from a femtosecond laser is converged into the glass member having the hydrogen loaded therein. Note that the laser beam from the femtosecond laser has an amount of energy causing a light-induced change in refractive index of the glass member and having a repetition frequency of 10 kHz or higher. In the light convergence point movement step, a position where the glass member is placed and/or a light convergence point position of the laser beam is continuously or intermittently changed, causing the light convergence point of the laser beam to move within the glass member.

### BRIEF DESCRIPTION OF DRAWINGS

FIG. 1 is a flowchart for describing a method for manufacturing an optical device according to an embodiment of the present disclosure.

FIG. 2 is a diagram showing a structure of a manufacturing apparatus that executes the method for manufacturing an optical device shown in FIG. 1.

FIG. 3 is a graph showing a measurement result of a change in transmittance relative to a wavelength of an incident light beam for each of different materials (SiO₂, GeO₂, B₂O₃) primarily forming a glass member.

### DESCRIPTION OF EMBODIMENTS

### Problem to be Solved by Present Disclosure

As a result of studying a conventional method for manufacturing an optical waveguide device, the inventors have found the following problems. That is, even with the method disclosed in Non-Patent Document 1, the maximum change in the refractive index is about Δn=0.015, and the light confinement is weak. Inevitably, the radius of curvature of the optical waveguide formed in glass increases, so that it is necessary to increase the size of the obtained optical device such as a three-dimensional optical waveguide device (an increase in size of the optical device). Further, in the method disclosed in Non-Patent Document 1, it is necessary to extend the irradiation time of the femtosecond laser beam with respect to a glass material necessary to obtain a desired increase in refractive index, it is difficult to increase the scanning speed of the femtosecond laser beam, and the manufacturing time becomes longer accordingly, which leads to an increase in manufacturing cost.

The present disclosure has been made in order to solve the above-described problems, and it is therefore an object of the present disclosure to provide a method for manufacturing an optical device that enables formation of a high refractive index region in glass, a reduction in size of an optical device such as a three-dimensional optical waveguide device, and a reduction in manufacturing cost, and an optical device obtained by the method for manufacturing an optical device.

### Effects of Present Disclosure

According to the present disclosure, it is possible to form a high refractive index region inside glass and reduce the size of an optical device such as a three-dimensional optical waveguide device.

### Description of Embodiment of Present Disclosure

First, details of the embodiment of the present disclosure will be individually listed and described.

(1) A method for manufacturing an optical device according to the present disclosure includes at least a hydrogen loading step, a laser irradiation step, and a light convergence point movement step as one aspect. A repetition of the laser irradiation step and the light convergence point movement step forms a continuous refractive index changed region in a glass member to be irradiated with a laser. Specifically, in the hydrogen loading step, hydrogen is loaded into the glass member containing Ge. The glass member having the hydrogen loaded therein is preferably glass containing no dopant other than Ge or glass doped with both B and Ge. In the laser irradiation step, a laser beam from a femtosecond laser is converged into the glass member having the hydrogen loaded therein. Note that the laser beam from the femtosecond laser has an amount of energy causing a light-induced change in refractive index of the glass member and having a repetition frequency of 10 kHz or higher. In the light convergence point movement step, a position where the glass member is placed and/or a light convergence point position of the laser beam is continuously or intermittently changed, causing the light convergence point of the laser beam to move within the glass member.

Note that the “light-induced change in refractive index” means herein a change in refractive index in glass induced by irradiation of light such as laser beam. Further, the “change in refractive index” is defined by a maximum difference in refractive index Δn in the light irradiation region where a change in refractive index has been produced, with reference to a refractive index of a region other than the light irradiation region. The change in refractive index Δn in the glass induced by irradiation of light is a combination of a change in refractive index Δnp (hereinafter, referred to as “pressure-induced change in refractive index”) caused by pressure (compressive stress and/or tensile stress) remaining in the glass and a change in refractive index Δnd (hereinafter, referred to as “structure-induced change in refractive index”) caused by a bonding defect of a dopant material occurring in the glass or composition fluctuation in the glass.

The pressure-induced change in refractive index Δnp is produced by, for example, laser irradiation causing an increase in density of a specific region in the glass as described in Non-Patent Document 1, and has a maximum value of about 0.015. Further, the structure-induced change in refractive index Δnd is produced by, for example, a refractive index increasing mechanism used in manufacture of fiber gratings and the like as described in Non-Patent Document 2 to Non-Patent Document 4.

In Patent Document 1 and Patent Document 2, a silica-based glass doped with a photosensitive material Ge is irradiated with a femtosecond laser to produce a large change in refractive index Δn (=Δnp+Δnd), but the change in refractive index is about 0.02 that is not enough. In order to further increase the change in refractive index Δn, H₂ needs to be loaded before irradiation.

Irradiating the glass member containing Ge and having H₂ loaded therein with the laser beam from the femtosecond laser increases the change in refractive index Δn of the laser beam irradiation region (light-induced region) and accelerates the formation of the change in refractive index Δn. In other words, both the pressure-induced change in refractive index Δnp and the structure-induced change in refractive index Δnd are produced in the laser beam irradiation region, and at this time, the H₂ loading makes can further increase the structure-induced change in refractive index Δnd, thereby forming a larger change in refractive index Δn (increase in light confinement efficiency). As a result, the radius of curvature in the refractive index changed region (optical waveguide region) formed in the glass member can be designed to be smaller, so that an optical device obtained can be reduced in size. Further, selection of an appropriate dopant makes it possible to reduce the manufacturing time.

(2) As one aspect of the present embodiment, the glass member may contain an element B. Further, as one aspect of the present embodiment, the light-induced change in refractive index of the refractive index changed region is preferably larger than 0.02. As one aspect of the present embodiment, the wavelength of the laser beam from the femtosecond laser is preferably in a range of from 400 nm to 540 nm or equal to or lower than 800 nm. In this case, both the pressure-induced change in refractive index Δnp and the structure-induced change in refractive index Δnd can be produced at the same position inside the glass member irradiated with the laser beam from the femtosecond laser.

(3) As one aspect of the present embodiment, in the hydrogen loading step, the glass member is preferably put into a hydrogen atmosphere of 10 atm or higher.

(4) An optical device according to the present disclosure is manufactured by any of the above-described embodiments or a combination the embodiments. In particular, as one aspect of the optical device, the glass member is preferably a silica-based glass, a phosphate-based glass, a halide glass, or a sulfide glass.

As described above, each of the aspects listed in “Description of Embodiment of Present Disclosure” is applicable to all remaining aspects or all combinations of the remaining aspects.

### Details of Embodiment of Present Disclosure

A description will be given below of details of specific examples of the optical device and the method for manufacturing the optical device according to the present disclosure with reference to the accompanying drawings. It should be noted that the present invention is not limited to these examples, and is intended to be defined by the claims and to include all modifications within the scope of the claims and their equivalents. Further, in a description of the drawings, the same components are denoted by the same reference numerals, and a redundant description will be omitted.

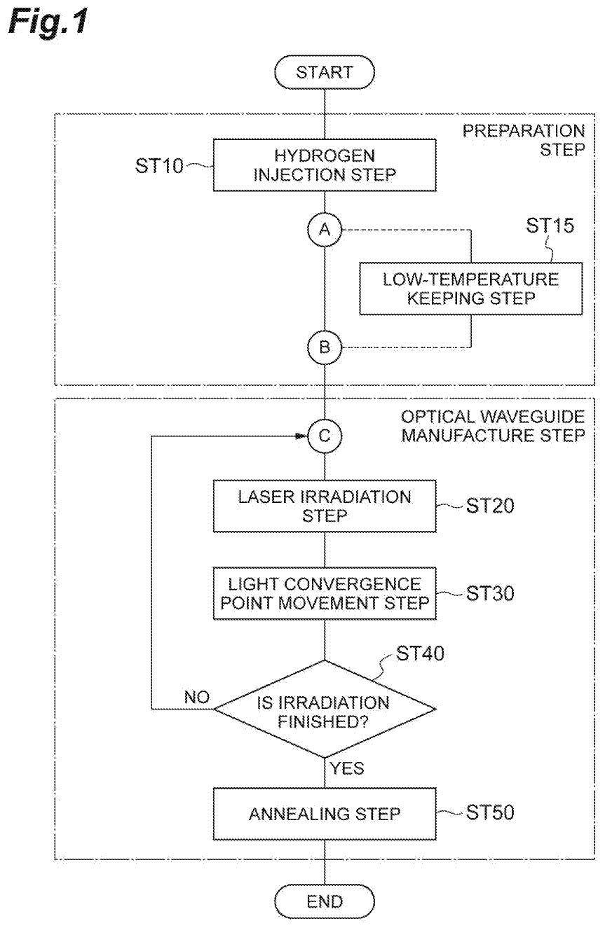

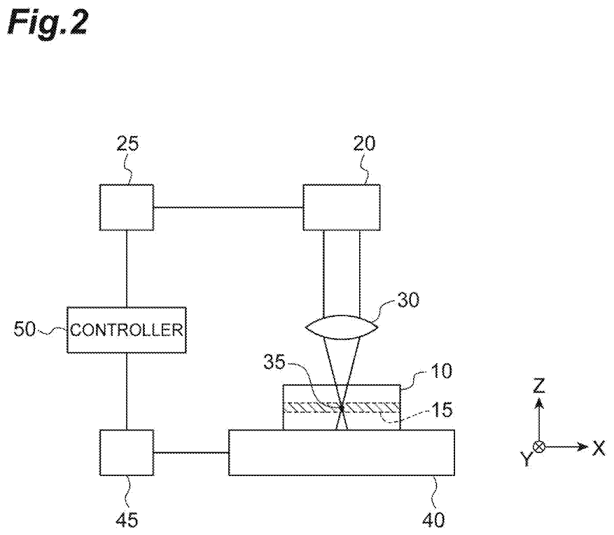

FIG. 1 is a flowchart for describing the method for manufacturing an optical device according to an embodiment of the present disclosure. Further, FIG. 2 is a diagram showing a structure of a manufacturing apparatus that executes the method for manufacturing an optical device shown in FIG. 1.

The manufacturing apparatus shown in FIG. 2 includes a femtosecond laser 20, a laser driver 25 that drives the femtosecond laser 20, a light convergence optical system (condenser) 30, an X-Y-Z stage 40, a stage driver 45 that drives the X-Y-Z stage 40, and a controller 50 that controls action of each of the components.

The laser driver 25 controls power and repetition frequency of a pulsed laser beam (hereinafter, referred to as a “femtosecond laser beam”) output from the femtosecond laser 20 in accordance with an instruction from the controller 50. This allows the femtosecond laser 20 to output the femtosecond laser beam having a pulse width of several hundred femtoseconds or less. In particular, the femtosecond laser beam whose pulse width is set to several hundred femtoseconds or less is effective because its peak power can be made to 10⁵ W or higher. Further, the repetition frequency of the femtosecond laser beam output is preferably equal to or higher than 10 kHz, so as to smooth a refractive index and structure of an optical waveguide formed in a glass material. On a device placing surface of the X-Y-Z stage 40, a glass member 10 to be an optical device is placed. The glass member 10 contains Ge so as to produce both the pressure-induced change in refractive index Δnp and the structure-induced change in refractive index Δnd by laser beam irradiation. More specifically, the glass member 10 is made of glass containing no dopant other than Ge, or glass doped with both B and Ge. Such glass is a silica-based glass, a phosphate-based glass, a halide glass, or sulfide glass. H₂ is pre-loaded into the glass member. The femtosecond laser beam output from the femtosecond laser 20 converges, by the light convergence optical system 30, into the glass member 10 (light convergence point position 35) placed on the X-Y-Z stage 40. This causes a refractive index changed region 15 (optical waveguide) is formed in the glass member 10.

The stage driver 45 drives the X-Y-Z stage 40 in accordance with an instruction from the controller 50 to move the device placing surface of the X-Y-Z stage 40 along an X axis, a Y axis, or a Z axis. Such a structure causes the light convergence point position 35 of the femtosecond laser beam to move relative to the glass member 10. The controller 50 controls action of each of the laser driver 25 and the stage driver 45 as described above, so that the refractive index changed region 15 having a desired pattern (corresponding to a shape of the optical waveguide projected onto an X-Y plane containing information on a depth direction along the Z axis) is formed in the glass member 10. (manufacture of an optical waveguide device serving as the optical device).

Next, a description will be given, with reference to the flowchart of FIG. 1, of a method for manufacturing an optical device according to the present embodiment, in which the manufacturing apparatus configured as described above is used to manufacture an optical device (the optical device according to the present embodiment). Note that, in the following description, a case of manufacturing a three-dimensional optical waveguide device (optical device) in which an optical waveguide (refractive index changed region) having a desired pattern is formed will be described as an example.

The method for manufacturing an optical device according to the present embodiment includes a preparation step and an optical waveguide manufacture step. First, in the preparation step, the glass member 10 (for example, a parallel flat plate glass) to be a three-dimensional optical waveguide device is prepared and temporarily placed in a chamber. With the glass member 10 placed, 100% hydrogen gas is introduced into the chamber, and pressure in the chamber is maintained at 10 atm or higher. A hydrogen loading period is in a range of from one day to half a year. This causes hydrogen to be loaded into the glass member 10 (step ST10). Note that when the optical waveguide manufacture step is not performed immediately after the hydrogen loading step in step ST10, the glass member 10 having the hydrogen loaded therein is kept at a temperature of −10° C. or lower to suppress an escape of the hydrogen from the glass member 10 (step ST15). Note that step ST15 (low-temperature keeping step) is performed during a period indicated by points A and B in FIG. 1.

In the optical waveguide manufacture step, an optical waveguide (refractive index changed region 15) having a desired pattern is formed in the glass member 10 having the hydrogen loaded therein. Specifically, the glass member 10 having the hydrogen loaded therein is placed on the device placing surface of the X-Y-Z stage 40 immediately after step ST10, and irradiated with the femtosecond laser beam (step ST20). The controller 50 controls the laser driver 25 to cause the femtosecond laser 20 to output the femtosecond laser beam having an amount of energy causing a light-induced change in refractive index in the glass member 10 and having a repetition frequency of 10 kHz or higher. The femtosecond laser beam output from the femtosecond laser 20 converges into the glass member 10 by the light convergence optical system 30 to cause the light-induced change in refractive index in the vicinity of the light convergence point position 35 of this femtosecond laser beam (light convergence region). When a predetermined portion of the glass member 10 has been irradiated with the laser, the controller 50 controls the stage driver 45 to shift the position of the glass member 10 placed on the device placing surface of the X-Y-Z stage 40 (step ST30). As described above, in the light convergence point movement step (step ST30), the position where the glass member 10 is placed and/or the light convergence point position 35 of the femtosecond laser beam is continuously or intermittently changed, causing the light convergence point position 35 of the femtosecond laser beam to move within the glass member 10.

Note that the laser irradiation step in step ST20 and the light convergence point movement step in step ST30, that is, the action control of the laser driver 25 and the action control of the stage driver 45 performed by the controller 50 are repeated until a pre-designed optical waveguide pattern is formed in the glass member 10 under fixed conditions or conditions changed when returning to point C in FIG. 1 (step ST40). When the optical waveguide (refractive index changed region 15) has been formed in the glass member 10 (step ST40), the glass member 10 is subjected to an aging treatment to keep Δn unchanged for a long time and is annealed to remove residual hydrogen (step ST50). Through the above steps (steps ST10 to ST50 or steps ST10 to ST50 including step ST15), a three-dimensional optical waveguide device is obtained.

Next, a description will be given of details of the laser irradiation step (step ST20) for manufacturing the three-dimensional optical waveguide device.

First, for the three-dimensional optical waveguide device to be manufactured, it is required that the laser beam converge to the glass member serving as a base material. That is, moving the light convergence region of the laser beam (including the light convergence point position 35) relative to the glass member while increasing the refractive index in the light convergence region (scanning a laser convergence region) forms the refractive index changed region having a desired pattern in the glass member. In order to form such a refractive index changed region having a desired pattern, a laser beam source and a light convergence optical system are required as an irradiation system, and a movable stage that operates in conjunction with the light convergence optical system is required. In the example shown in FIG. 2, the femtosecond laser 20 serving as the laser beam source and the laser driver 25, the condenser serving as the light convergence optical system 30, and the X-Y-Z stage 40 and the stage driver 45 serving as the movable stage are provided. The controller 50 controls the action of each of the components.

Mechanisms for increasing the refractive index in the glass member by causing the laser beam to converge to the glass member are classified into the following two mechanisms.

A first mechanism is a refractive index increasing mechanism using a Ti:S laser (a femtosecond laser having a wavelength of 800 nm or lower). According to the refractive index increasing mechanism using the Ti:S laser, high-pressure plasma is produced in the glass member to which the laser converges. In the laser convergence region of the glass member, dynamic compression caused by an impact of the high-pressure plasma produces and propagates pressure waves outward, so that glass in the laser convergence region is made coarse. Further, after the laser irradiation, an elastic constraint applies a compressive stress to a center of the laser convergence region, so that a high-density glass region is formed in the glass member. At this time, the change in refractive index Δn in the high-density glass region becomes about 0.015 (see Non-Patent Document 1). The change in refractive index caused by the first mechanism corresponds to the pressure-induced change in refractive index Δnp.

Note that the laser wavelength used may be about 800 nm as described above, or may be in a range of from 400 nm to 540 nm. In the wavelength range of 800 nm or lower, a laser (for example, a Ti:S laser) that outputs a stable laser beam is available. The effectiveness of the wavelength of from 400 nm to 540 nm will be described later. However, it is difficult for the first mechanism (Δn production method using high-pressure plasma) in which a change in refractive index is produced starting from the high-pressure plasma to further increase the change in refractive index Δn. Therefore, in the present embodiment, a Δn production method used for a fiber grating (second mechanism) is employed.

In the second mechanism, a glass member doped with GeO₂ or the like is put into a high-pressure atmosphere of hydrogen, so that hydrogen is loaded into the glass member. Subsequently, the glass member having the hydrogen loaded therein is irradiated with a UV laser of about 250 nm. The reason why the UV laser of about 250 nm is used is that the UV laser breaks bonds of a dopant material such as GeO₂ (a bonding defect of the dopant material) and induces a high-density change of glass due to composition fluctuation of H₂, Ge, Si, and O (see Non-Patent Document 3 and Non-Patent Document 4 described above). Further, the formation of the change in refractive index Δn is accelerated by the effect of an element B, and the change in refractive index Δn thus produced becomes about 0.01 (see Non-Patent Document 2 and Non-Patent Document 4 described above). The change in refractive index produced by the second mechanism corresponds to the structure-induced change in refractive index Δnd.

According to the present embodiment, it is expected that a combination of the first mechanism that produces the pressure-induced change in refractive index Δnp in the glass member and the second mechanism that produces the structure-induced change in refractive index Δnd in the glass member produces a change in refractive index (a light-induced change in refractive index) Δn larger than 0.02 at the maximum. As described above, according to the present embodiment, since a change in refractive index in the glass member larger than in the related art can be produced, that is, light confinement efficiency of a high refractive index region (optical waveguide) formed in the glass member is increased, it is possible to reduce the size of the optical device such as a three-dimensional optical waveguide device. This also makes it possible to increase the manufacturing speed.

(Wavelength of Laser Beam)

It is required that the glass member that is to be manufactured as the optical device according to the present embodiment and is applied to, for example, the above-described three-dimensional optical waveguide device contain a dopant uniformly throughout the glass. Therefore, it is not possible to dope only a region (core) where it is desired to increase the refractive index with a dopant such as GeO₂, unlike a fiber grating, for example. When the glass member doped with GeO₂ or the like is entirely irradiated with a UV light beam, even with an irradiation optical system capable of causing a light beam to converge to a desired position built, the UV light beam is absorbed immediately after entering into the glass member; therefore, required energy cannot be concentrated in a light convergence region of the UV light beam. Even if the required energy can be concentrated in the light convergence region of the UV light beam, the refractive index will be increased over a region extending from an incident surface of the glass member to the light convergence region of the UV light beam, which makes it difficult to form a desired optical waveguide in the glass member.

Therefore, according to the present embodiment, two-photon absorption that is equivalent to energy having a wavelength of about 250 nm is used instead of the UV light beam. That is, according to the present embodiment, a laser beam having a high peak power with a wavelength of about 500 nm is made incident on the glass member to increase a photon density in the laser convergence region of the glass member. When the probability of two-photon absorption increases as described above, the bonds of the dopant material (such as GeO₂) are broken by energy having a wavelength of about 250 nm, and composition fluctuation can be induced accordingly. Herein, in order to increase the photon density in the laser convergence region, a focal length of the condenser is preferably equal to or less than 100 mm. Further, as the condenser, an achromatic lens capable of suppressing chromatic aberration produced by multiwavelength components of a short-pulsed laser is effective. When the wavelength of the irradiation light beam is equal to or higher than 800 nm, it is necessary to efficiently produce three or more photon absorption; therefore, the condenser preferably has f=100 mm or less.

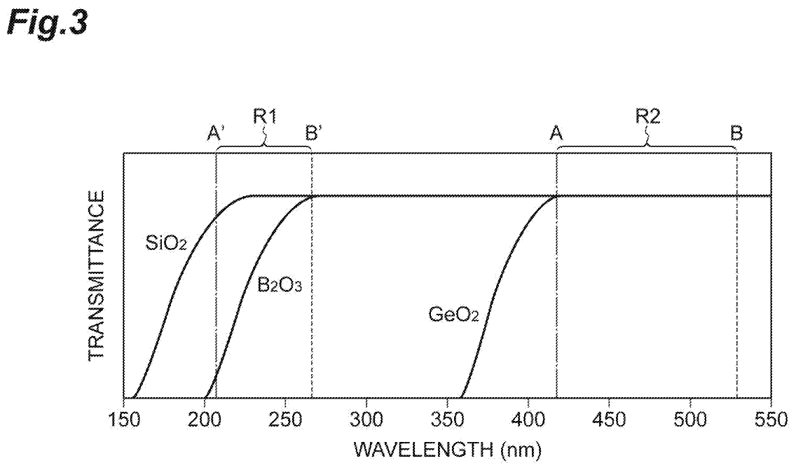

Further, there is an effective laser wavelength range from the viewpoint of the wavelength at which the dopant material (such as GeO₂) is prevented from being absorbed and the energy that breaks the bonds of the dopant material. FIG. 3 is a graph showing a measurement result of a change in transmittance relative to a wavelength of an incident light beam for each of different materials (SiO₂, GeO₂, B₂O₃) primarily forming the glass member. Note that, in FIG. 3, a wavelength range R1 between A′ line and B′ line denotes a wavelength range corresponding to two-photon absorption, and a wavelength range R2 between A line and B line denotes an incident wavelength range.

For example, an end of a band gap of GeO₂ is located on a longer wavelength side as compared to a band gap of B₂O₃, and GeO₂ absorbs light up to about 400 nm. Therefore, an end on a shorter wavelength side of the incident wavelength range R2 is preferably equal to or higher than 400 nm of A line where the material does not absorb light. Since the wavelength of 400 nm is transparent to the material, the laser beam incident on the glass member converges to a predetermined position in the glass member. Since the energy of two-photon absorption at the wavelength of 400 nm is equivalent to about 200 nm, it is possible to break both bonds of B₂O₃ and GeO₂. As a result, it can be seen that the laser beam having a wavelength of 400 nm or higher is effective in inducing composition fluctuation in the glass member. On the other hand, a condition for a limit on a longer wavelength side (upper limit) of the incident wavelength range R2 is that energy that can break bonds of all dopant materials is required. In this case, since the wavelength of the energy obtained by two-photon absorption is equal to or lower than 270 nm (a limit on a longer wavelength side of the wavelength range R1) at which the absorption of B₂O₃ begins, it is required that the limit on the longer wavelength side (upper limit) of the incident wavelength range R2 be equal to or lower than 540 nm.

From the above, for the dopant materials of B₂O₃ and GeO₂, the wavelength (incident wavelength) of the laser beam incident on the glass member is particularly effective in a range of from 400 nm to 540 nm. In addition, setting the wavelength of the laser beam to the range of from 400 nm to 540 nm makes it possible to cause the positions where both the pressure-induced change in refractive index Δnp and the structure-induced change in refractive index Δnd are produced to coincide with each other; therefore, it is extremely effective in manufacturing a three-dimensional optical waveguide device or the like as the optical device as in the present embodiment.

Note that, in a case where laser beams having different wavelengths are used, usually, two types of laser beams having a wavelength of 450 nm and a wavelength of 225 nm are collected by the condenser. When an achromatic lens is used as the condenser, it is difficult to completely eliminate chromatic aberration (convergence points of laser beams having their respective wavelengths are different from each other). That is, since the pressure change in refractive index Δnp and the structure-induced change in refractive index Δnd are produced in different regions in the glass member, it is difficult to design a highly accurate optical waveguide (high refractive index region to be formed in the glass member).

Further, other than the laser beam irradiation based on the wavelength selection as described above, using a laser beam having a wavelength of about 800 nm from the Ti:S laser to produce the pressure-induced change in refractive index Δnp induced by plasma and the structure-induced change in refractive index Δnd produced by multiphoton absorption more than two-photon absorption is also effective.

In addition, as a condition required for the laser beam source, a fundamental wavelength of a solid laser, a gas laser, a fiber laser, or the like whose pulse width is narrower than 1 picosecond and has a high peak power, or a wavelength converted wavelength is effective. In particular, a pulse width equal to or narrower than several hundred femtoseconds is effective because the peak power can be made equal to or higher than 10⁵ W. Further, the repetition frequency of the pulsed laser beam output from the laser beam source is desirably equal to or higher than 10 kHz, so as to reduce the manufacturing time.

### REFERENCE SIGNS LIST

10 . . . Glass member; 15 . . . Refractive index changed region (optical waveguide); 20 . . . Femtosecond laser; 25 . . . Laser driver; 30 . . . Light convergence optical system (condenser); 40 . . . X-Y-Z stage; 45 . . . Stage driver; and 50 . . . Controller.

1. A method for manufacturing an optical device, comprising:
loading hydrogen into a glass member containing Ge;
irradiating a laser beam from a femtosecond laser to converge into the glass member having the hydrogen loaded therein, the laser beam having an amount of energy causing a light-induced change in refractive index of the glass member and having a repetition frequency of 10 kHz or higher; and
moving a light convergence point position of the laser beam relative to the glass member, wherein
a repetition of the irradiating and the moving forms a continuous refractive index changed region in the glass member.

2. The method for manufacturing an optical device according to claim 1, wherein
the glass member contains B.

3. The method for manufacturing an optical device according to claim 1, wherein
the laser beam has a wavelength of from 400 nm to 540 nm.

4. The method for manufacturing an optical device according to claim 1, wherein
the laser beam has a wavelength of 800 nm or lower.

5. The method for manufacturing an optical device according to claim 1, wherein
in the loading, the glass member is put into a hydrogen atmosphere of 10 atm or higher.

6. An optical device manufactured by the method for manufacturing an optical device according to claim 1, wherein
the glass member is a silica-based glass, a phosphate-based glass, a halide glass, or a sulfide glass.

7. An optical device manufactured by the method for manufacturing an optical device according to claim 1, wherein
the light-induced change in refractive index of the continuous refractive index changed region is larger than 0.02.
